(19) United States
(12) Patent Application Publication
(10) Pub. No.: US 2022/0354107 A1
(43) Pub. Date: Nov. 10, 2022

(54) Rapidly Deployable and Adjustable Fail-Safe Tree Stand and Integrated Harness with Seat

(71) Applicant: Back Mountain Outdoor Products, Inc., Dallas, PA (US)

(72) Inventor: Michael Castner, Dallas, PA (US)

(21) Appl. No.: 17/302,613

(22) Filed: May 7, 2021

(51) Int. Cl. A01M 31/02; A62B 35/00

(52) U.S. Cl. CPC A01M 31/02; A62B 35/0006

(57) ABSTRACT

The invention is a rapidly adjustable, inherently safe, mobile climbing tree stand with harness of the type used by hunters to ascend and descend a tree and to furthermore remain seated in a fall protected mode while at height in a tree. The inherently safe tree stand has redundant fail safe fall protection and utilizes ANSI standard arborists ge

### CROSS REFERENCE TO RELATED APPLICATIONS

This non-provisional patent application claims priority to U.S. Provisional Patent Application 67/704,403 “Improved Rapidly Adjustable Fail Safe Tree Stand and Integrated Harness with Seat” filed May 8, 2020

### FEDERAL RESEARCH STATEMENT

None

### BACKGROUND OF THE INVENTION

The present invention relates generally to a tree stand of the type used by hunters to safely ascend a tree and safely and comfortably remain in an elevated position above the floor of the forest. More specifically the instant device is a modified portable tree stand that is lightweight, rapidly deployable, easily erectable, rapidly adjustable, inherently safe and has a flexible and mobile harnessed reclinable seat integrated into the tree stand. Whereas many tree stands are permanent, the present invention can be moved easily from tree to tree with only a small portion of the required hardware permanently affixed to a tree.

### DESCRIPTION OF THE PRIOR ART

The prior art teaches many types of tree stands used to provide a light weight, portable elevated platform and seat in a tree for hunters. In recent years, climbing tree stands have become more and more popular. Such climbing tree stands are comprised of an upper seating section and a lower standing section. Both the upper section and the lower section are connected to the tree, normally by a flexible belt or cable. While these climbing tree stands have proven to be an improvement when compared to older generations of tree stands, they are bulky, difficult to move from tree to tree, are somewhat unsafe and often have restricted fields of vision.

As a hunter climbs a tree, the decreasing diameter and/or the angle of “lean” of the tree trunk causes the rear of each conventional prior art stand section to tilt downward or upward. In order to level the stand and thereby minimize the risk of falling, the hunter must adjust the cable or belt length. Similarly, as the hunter descends the tree, the cable or belt must be adjusted to maintain the section level. The present invention resolves this problem by always being in a level position with respect to the ground regardless of the lean or decreasing diameter of the tree.

The original versions of climbing tree stands were difficult to keep level. Recent contributions to the prior art provide various means for adjusting the cable length in order to keep the stand level. For example, U.S. Pat. Nos. 6,182,792; 5,234,076; and 5,097,925 are all examples of climbing tree stands using flexible cables as attaching members. Most of the devices taught in the aforementioned patents were difficult to adjust and make level while the hunter was actually climbing up the tree in the stand. U.S. Pat. No. 7,287,623 to Graham teaches a method for adjusting the climbing tree stand while the hunter is in the stand by the use of a geared leveling system that features a hand crank/gear assembly. While this device represents a significant improvement in the technology of adjustable climbing tree stands, it is still relatively difficult to make the stand level especially in the dark or in cold weather.

There are several other problems inherent in the current generation of climbing tree stands including: obstructed lines of sight resulting from the tree that the stand is mounted on; safety concerns as a result of a hunter leaning over the side of the stand; additional safety concerns resulting from an inadequate level of “grip” or “bite” onto the tree by the teeth of the stands; and the ever present problem of wet weather causing the seat to become wet during rainy periods and moldy when left alone. All these issues are resolved by the instant invention.

Many injuries occur each year as a result of hunters falling from tree stands. The most recent statistics show that an average of 3,000 serious accidents occur each year as a result of falling from a tree stand. Many injuries occur during ascent or descent. Some occur when a hunter falls asleep and slumps over. Others occur when a hunter excitedly moves quickly to aim and shoot at a target. Still others occur when a hunter is numbed by the cold and is unable to safely move in the tree stand. Whatever the reason, the medical and rehabilitation costs for hunters who survive a fall from a tree stand run into many tens of millions of dollars per year. Some hunters are permanently injured and can no longer work or fend for themselves. The dozens of fatalities that occur each year result in incalculable losses to families, businesses, and communities. The current generation of tree stands has made limited progress in addressing tree stand safety, but the prior art has thus far failed to completely solve or even mitigate the problem.

For all the reasons presented above, there is a significant need for inherently safe or fail-safe tree stands. The instant invention solves these problems by disclosing a lightweight, portable, comfortable, easily deployable fail-safe tree stand that incorporates a safety harness suspended from an independent, strong, heavy duty climbing rope that is fixed above the optimal height for the tree stand. The seat of the instant invention is essentially a modified reclinable bosun's chair or seat that is included for the comfort of the hunter therefore allowing him or her to remain in the tree for extended periods of time. The modified bosun's chair is not attached to any of the safety equipment. The instant invention furthermore incorporates the concept of defense in depth to virtually eliminate the accidental falls from tree stands that have plagued the hunting community for years. There are multiple safety features built into the present invention so that in the unlikely event that one of the safety features fails or is bypassed or misused, one of the other safety features will prevent a fall. Of particular importance is the safety feature that offers significant fall protection and specifically prevents falls during ascent and descent.

### SUMMARY OF THE INVENTION

The present invention relates to a rapidly adjustable, portable, lightweight, rapidly deployable, inherently safe, reclining climbing tree stand with harness of the type used by hunters to safely ascend or descend a tree as well as a fall protecting method for remaining in a tree stand for extended periods of time. A key aspect of the present invention is that it allows for movement around the entire circumference of the tree while the hunter is safely in an elevated position, thereby eliminating the issue many hunters in a static tree stand face when a target is screened by the tree. In addition, the present invention can be used as a ground level seat and harness if ascending a tree is not feasible or desired. The current generation of tree stands has the inherent problem of having the tree upon which the stand is mounted present a significant and formidable obstacle which the hunter can only overcome by placing himself at peril by leaning over the side of the tree stand. The instant invention allows the hunter to be suspended in a comfortable bosun's seat with safety harness affixed to the upper part of the tree thereby increasing significantly his ability to avoid the obstruction presented by the tree trunk. The bosun's seat is not necessarily part of the ANSI rated safety equipment. However, in the best mode of practice, straps from the bosun's seat are attached by a carabiner to the bottom loop of the friction knot and therefore the bosun's seat is incorporated into the overall safety scheme of the present invention.

Another significant safety feature is that the harness is designed such that the harness straps that go around the upper leg and thigh are loose once the hunter is at the desired height and the bosun's seat has been deployed. This results in significantly less pressure on the femoral arteries than is present in other harness configurations. This is significant in that a hunter's circulation can be affected if he/she is suspended by a harness for extended periods of time as would be the norm in harness only tree stands. Essentially, in the present invention, the pressure is on the upper leg arteries only during ascent and descent. When the hunter is at the desired height and the seat is deployed, the pressure is off the upper leg arteries. The harness may be a standard arborist's tree harness and may include slight modifications. These modifications do not detract from the safety aspects of the harness, which remains fully compliant with ANSI standards.

The major components of this invention are: (a) a heavy duty climbing rope with a heavy duty mechanical stop (b) a safety harness, (c) an adjustable, reclinable seat with back and head rest, (d) a trailing rope grab, (e) an arborist's hand ascender, (f) an attachment point, (g) a base walkway/footrest, (h) optional modular ladder sections known as sticks, (i) an optional safety life line, (j) a foot ascender, (k) a modified Prusik or VT-Prusik or any similar friction knot, and (l) a throw rope.

The attachment point can either be a galvanized eye lag bolt permanently attached to the tree, a metallic strap such as a ratchet strap with an attached arborist's ring or something similar. The attachment point is ideally located a few feet above the hunter's ideal elevation. However, the exact location of the attachment point is at the hunter's discretion. A lightweight arborist throw rope or something similar permanently runs through the ring of the attachment point. The arborists throw rope may be left permanently in the subject tree. The heavy duty climbing rope is ANSI approved and may not be permanently left outside in the tree. When the instant device is initially installed in a tree, the hunter will normally use sticks to be able to ascend the tree and install the attachment point at the desired height. Initially, it will be advisable to use a heavy duty ratchet strap with an arborist's ring as the attachment point. A threaded galvanized eyebolt or similar device can be screwed into the tree. At first the threaded eyebolt may not be optimally secure. However, over time as the tree grows, the threated eyebolt will become integral with tree and provide a more than optimally secure attachment point. After the attachment point has been successfully installed and weight tested, the sticks may be removed. The sticks can be moved to another tree for installation of an attachment point at the tree.

The heavy duty climbing rope is attached to one end of the throw rope. The throw rope is then pulled so that the throw rope is raised up to the attachment point. The mechanical stop on the throw rope engages the ring and firmly secures the climbing rope in place. The heavy duty climbing rope is capable of holding weight in excess of five hundred pounds. The heavy duty climbing rope is ANSI approved.

The harness may be an arborist's harness that is certified by ANSI. Such harnesses may be capable of holding and suspending persons up to 350 pounds or more.

The trailing rope grab may be any ANSI approved rope grab rated to 350 lbs or more.

The reclinable seat may be a modified bosun's chair or seat or any other type of seat that can be taken up the tree in a collapsed position and then transformed from the collapsed to the deployed position. The seat may have the ability to recline in a variety of positions ranging from a straight back 90 degree upright seat to a fully reclinable seat by adjusting the positioning of the straps that hold the seat to the carabiner or other similar device attached to the friction knot.

A key feature of the present invention is its portability. One of the drawbacks of most tree stands is that a complete tree stand set up/apparatus is needed for each tree that the hunter wants to observe and shoot from. Most hunters want to have tree stands in multiple trees at various points on their property. This can become prohibitively expensive and therefore most hunters are relegated to having a tree stand in a few trees. The present invention solves this problem by being 95% portable. The only items that are permanently affixed to any give tree are (a) the ratchet strap with arborist's ring, (b) the threaded eye bolt, and (c) the arborists throw rope. These items are inexpensive. In fact, the ratchet strap may be removed after the threaded eye bolt becomes permanently affixed to the tree—generally after a few years. The major components of the portable tree stand can be quickly and easily moved from tree to tree. For example, if the hunter wants to spend a few hours in one tree in the morning, he/she can quickly ascend the tree and remain comfortably in the tree. He/she can then descend the tree, have some lunch, and go to another tree and spend the afternoon there. Another key feature is that it takes only a few minutes to set up, ascend the tree, deploy the seat and remain comfortably and securely in the tree. The total weight of the portable tree stand is less than 20 pounds and should not be an issue for most hunters to carry and deploy.

While the present invention is disclosed within the context of use by a hunter, many of the attributes of the invention will be found to be useful by a variety of other persons in various vocations and avocations such as wildlife photographers, tree trimmers, naturalists, painters, window washers and the like. As such, whenever the term “hunter” is used in this disclosure, it is assumed to be applied globally to any person who has the occasion to work from an elevated position above ground. In addition, the term “hunter” shall apply equally to a male or female.

### SAFETY FEATURES

The primary innovative feature of the present invention is its overall inherent safety. Another key aspect is the Fail-Safe attributes. In other words, in the unlikely event that a component fails, the system reverts to a safe configuration. An unlikely failure of any component will not result in situation which could cause injury or death. As long as the hunter follows the procedure and does not take any short cuts, he/she will be able to safely ascend, descend and remain in the tree stand for many hours. All associated safety equipment (i.e. attachments, arborist rings, ratchet strap, harness, ascender/descender, rope hand ascender, mechanical stop, etc.) are all ANSI approved to ANSI Standard Z133. Another key safety feature is that all the safety equipment does not stay outside in the atmosphere indefinitely which is a violation of ANSI rules. Instead, all the key safety equipment is easily removed from the tree and stored inside. In addition, with all other tree stands there is no permanent safety system. The hunter has to rely on incorporating safety equipment from another manufacturer with the rope and Prusik friction knot apparatus.

In conventional prior art tree stands equipped with fall protection, if the hunter falls, several things can happen that can be detrimental to the hunter's safety. In the first instance, conventional tree stands that are configured with a Prusik-style knot require that considerable slack be built into the system due to the fact that since you need slack because you have to sit and then stand to shoot. Due to this slack, if the hunter falls, there is a significant shock load applied to the Prusik knot. This shock load tightens the Prusik knot to the extent that it is difficult to loosen it and the hunter either has to cut the rope or try to undo/loosen the knot which is quite difficult. At this point, the hunter is faced with a significant dilemma as he/she must decide whether to cut the rope or remain in the tree and become susceptible to suspension trauma or hypothermia.

A second problem that may be encountered is that if a person falls from a conventional prior art tree stand, the hunter's face can hit the tree, the foot rests or sticks and serious injury (e.g. broken jaw, broken nose, teeth knocked out, rendered unconscious) may occur. All of these types of accidents have happened in the past and are therefore real and legitimate threats. With the present invention, there is no chance of falling because there is no slack. The hunter does not have to rise from a seated position to shoot and therefore there is no requisite slack. Additionally the present invention is so configured such that the hunter can let himself/herself down out of the tree so there is no chance of suspension trauma. Finally the harness in the instant invention is an arborist's harness that attaches in the front and not on the top like the other harnesses in the prior art. This prevents suspension trauma also because the instant system actually incorporates all the safety gear (including the rope) into the system. The safety gear is default and must be used. The system can not be used without the safety gear.

The climbing rope is a heavy duty, weather resistant synthetic rope that can be used and engaged for both ascent and descent. The hunter climbs/ascends by the stand-sit method up the rope using an ascender/descender and a hand ascender and adjustable length foot loop.

The base walkway/footrest attachment is a mechanical device that attaches to the tree approximately 20 to 30 feet about the ground. The exact positioning/height above ground is at the hunter's discretion. It is used as a resting place for the hunter's feet while he or she is suspended in the harness above the ground. It allows the hunter to move around the entire circumference of the tree while suspended in the harness. Optional footrests can be attached to a tree at a desired height by the hunter. These footrests allow the hunter to fully extend and rest his or her legs while the seat is in a reclining position.

A key feature of the present invention is the inherent safety of the device. The rope grab results in the fact that if the hunter slips, he or she only falls a few inches before the rope grab engages and stops the fall. The rope grab also has a locking mechanism that serves to further hold the apparatus in place against the rope. A third key feature is the lifeline that is securely fastened to the tree and is also attached to harness and prevents the hunter from falling once he or she has ascended the tree.

In an alternate mode, the apparatus may be used for ground hunting. In this instance, the device (without the safety harness) is set up approximately five to eight feet above the ground.

While the present invention is directed towards hunters who wish to hunt from an elevated position in a tree, aspects of the present invention may also be applicable to other pursuits such as wildlife photographers and window washers. In short, just about any vocation or avocation the requires a person to be suspended above ground for extended periods of time will find that attributes of the present invention will make their pursuits easier and safer.

### BRIEF DESCRIPTION OF DRAWINGS

FIG. 1 shows the hunter sitting comfortably and safely in the instant inherently safe tree stand 10.

FIG. 2 shows the sticks leading up to the attachment point, the throw line with the attached climbing rope being pulled through the attachment point.

FIG. 3 shows a close up view of the rope grab, the harness, and the optional hand ascender.

FIG. 4 shows the hunter about to ascend the tree with the following equipment: the foot ascender, the trailing rope grab, the safety lightweight harness, the arborists rope, and the modified bosun's seat assembly (not shown) on the hunter's back as he prepares to scale the tree.

FIG. 5 shows the hunter ascending the tree along the rope using the foot ascender and the hand ascender together.

FIG. 6 shows the hunter in the static position sitting comfortably and safely on the bosun's chair. At this point, the bosun's chair is attached to an attachment point such as an arborists ring or ratchet strap.

FIG. 7 shows the hunter in the shooting position on the other side of the tree. This configuration allows the hunter to move noiselessly around the entire azimuth of the tree with virtually no noise and with obstructed view from the tree stand.

FIG. 8 shows some of the equipment used in the present invention including the climbing rope, threated eye bolt, hand ascender, foot ascender, and trailing rope grab.

### DETAILED DESCRIPTION OF THE INVENTION

The present invention relates generally to a tree stand of the type used by hunters to safely ascend a tree and safely and comfortably remain in an elevated position above the floor of the forest. More specifically the instant device is a modified portable tree stand that is lightweight, rapidly deployable, easily erectable, rapidly adjustable, inherently safe and has a flexible and mobile harnessed reclinable seat integrated into the tree stand. Whereas many tree stands are permanent, the present invention can be moved easily from tree to tree with only a small portion of the required hardware permanently affixed to a tree. Permanent tree stands are subject to failure due being exposed to the elements for protracted periods of time. The instant invention solves this issue by allowing the hunter to take the key safety related aspects of the invention inside and out of the elements after use.

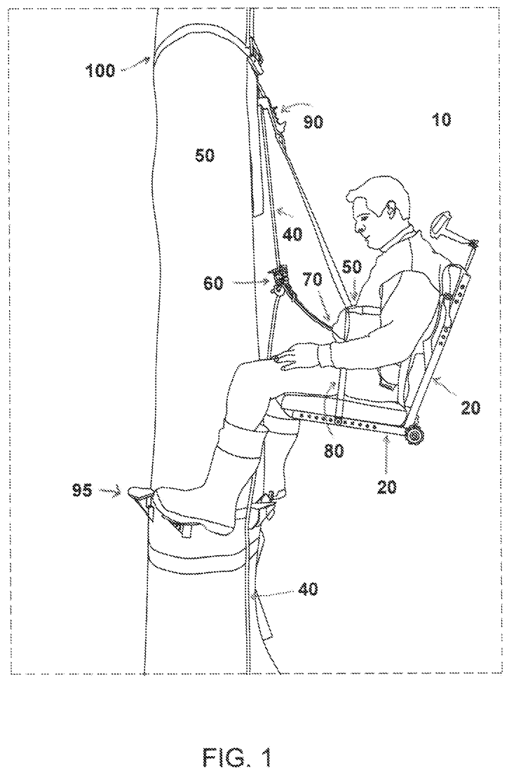

Referring to FIG. 1, the hunter is shown seated comfortably in the portable tree stand 10 while it is firmly and safely attached to a tree 50. The various major components of the tree stand are: a safety harness 80 and collapsible seat assembly 20, a friction knot 90, the climbing rope 40, the trailing rope grab 60 attached to the safety harness 80, a ratchet strap firmly secured to the tree with an arborist's ring attached to the strap, foot rests 95. The ratchet strap 100 and attached arborists ring (not shown) and the throw line are the only items of the present invention that remain in the tree. All other parts of the invention can be and should be removed from the elements every evening.

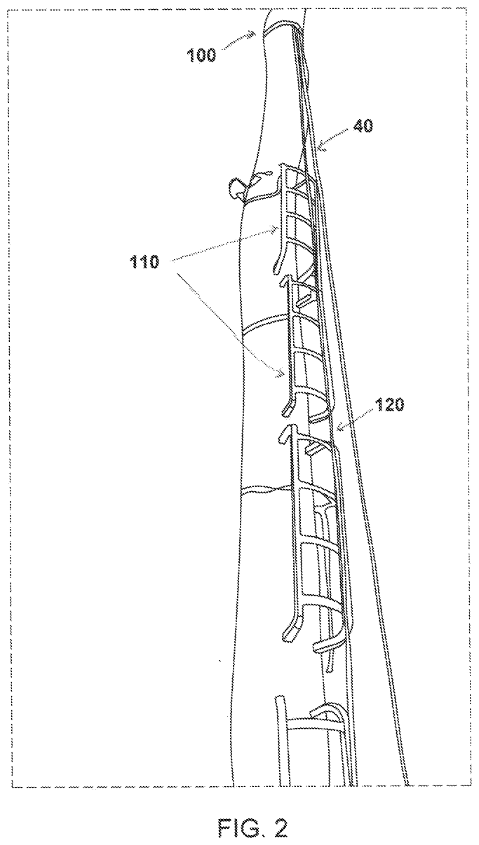

Referring to FIG. 2, the ladder sections (known in the industry as “sticks”) 110 are shown attached to the tree. In the initial setup phase, the hunter must place the ratchet strap 100 with attached arborist's ring at the desired height, which is generally 20 to 30 feet above the ground. The hunter will ascend the sticks to position the ratchet strap at the desired height. During the initial setup, the hunter may also screw a threaded heavy duty eyebolt with a minimum 2,500 pound breaking strength into the tree. As the years go by and the tree grows, the heavy duty eyebolt will become more and more embedded in the tree thus resulting in an extremely strong and resilient attachment point for the instant tree stand. When the ratchet strap with attached arborist's ring is firmly attached, the hunter then threads an arborist's throw rope 40 through the arborist's ring with sufficient length to reach the ground. Also shown is the climbing rope 120

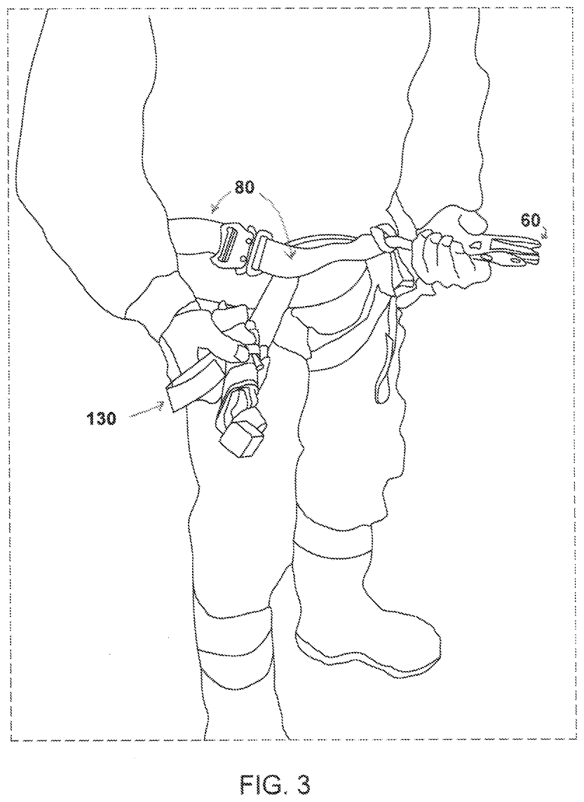

Referring to FIG. 3, an enhanced closeup of the trailing rope grab 60 attached to the safety harness 80 is shown. The trailing rope grab 60 is a descent limiting apparatus that only allows a hunter to slip a few inches if he or she loses his or her balance in the tree stand. The trailing rope grab 60 also incorporates a locking mechanism that holds the rope grab in a fixed position with respect to the climbing rope. Also shown is an additional safety line 130.

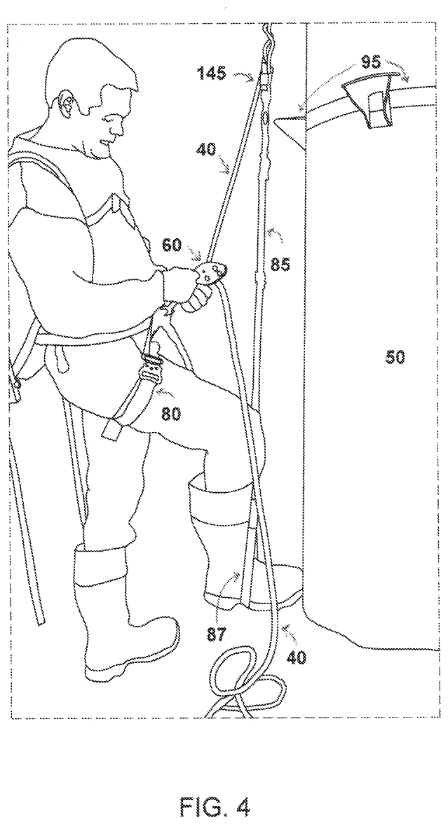

FIG. 4 shows the hunter ready to start to ascend the tree 50. The hunter is fully engaged in the safety harness 80 and the bosun's seat assembly in the collapsed mode is attached to the hunter's back. The climbing rope 40 (an ANSI approved arborist's climbing rope) is shown properly threaded through trailing rope grab 60 which in turn is attached to the safety harness 80. A foot ascender 85 is attached at one end to a carabiner or similar device attached to the bottom of a friction knot 145. The hunter's foot is placed into the loop of the foot ascender 87 near ground level.

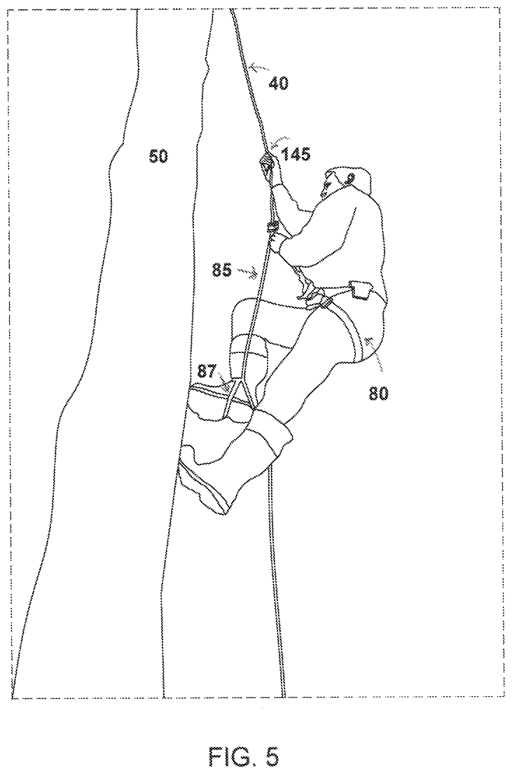

FIG. 5 shows the hunter ascending the tree using the instant invention in conjunction with the stand-sit method of moving up a tree. In this case, the upper end of the foot ascender is attached to a carabiner 147 affixed to the bottom loop of the friction knot 145. The hunter's right hand grasps the friction knot and moves it upwards from 12 to 18 inches. This has the effect of lifting the leg engaged in the foot ascender up. With his left hand, the hunter grabs the climbing rope and pulls himself up the 12 to 18 inches while essentially standing up. At the same time, the hunter pulls the climbing rope up with his left hand to take the slack out of the climbing rope. In this view, the modified bosun's seat is not shown in order that the other components of the instant invention can be readily seen and understood. Normally, the modified bosun's seat is attached to the hunter's back. It is important to note that the total weight of component parts of the present invention is less than 20 pounds.

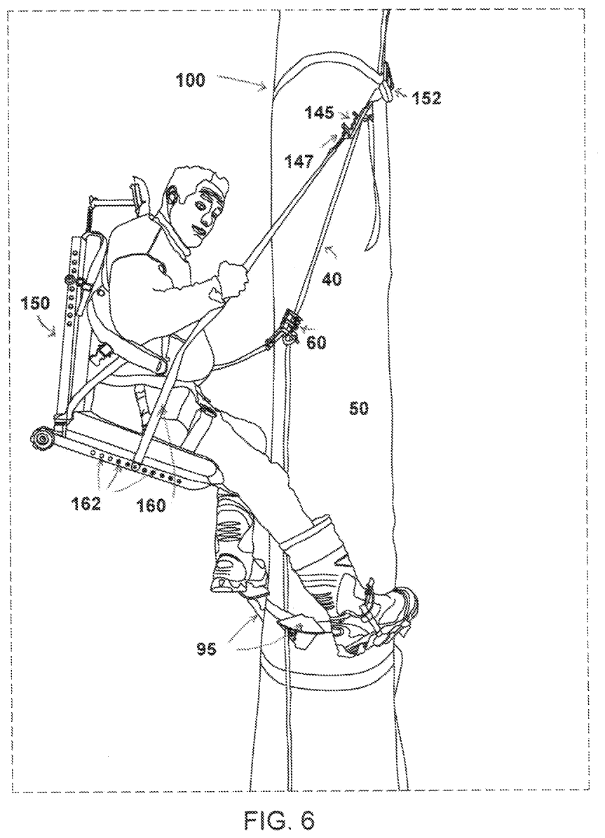

Referring to FIG. 6, the hunter is shown with the instant invention fully deployed at the desired height in a tree. The modified bosun's seat 150 has been deployed from the collapsed position to the seated position. The safety straps 160 attached to the bosun's seat are affixed to the carabiner 147 affixed to the bottom of the friction knot 145. In this configuration rope/trailing rope grab assembly is in a slack position, which results in pressure being taken off the portion of the safety harness 80 that goes under the hunter's thighs. This is important since there is no undue pressure on the key femoral arteries in the legs. In other harness-oriented tree stands, there is significant pressure on the femoral arteries which can lead to blood flow problems if the hunter stays aloft too long. FIG. 6 also shows the arborist's ring 152 attached to the ratchet strap 100.

The defense in depth aspect of the instant invention is also exhibited in FIG. 6. As mentioned above, the safety straps leading from the modified bosun's seat are attached to a carabiner or similar device affixed to the bottom of the friction knot. The friction knot holds the bosun's seat firmly in place. In the highly unlikely event that the friction knot or the carabiner or the straps fail and the hunter begins to fall, the trailing rope grab 60 will engage the climbing rope and stop the fall after only a few inches of rapid descent.

FIG. 6 also shows the hunter resting his feet on the walkway 95. This is another case of the instant invention being built for long term comfort and staying power in the tree stand without putting undue stress on legs, knees, or arms. Note also that the bosun's seat can be switched into many positions from essentially a straight back chair to an almost fully reclined position by moving the attachment points straps to the various positions 162 on the frame of the modified bosun's seat. This has the added benefit of not keep the hunter in the same position for too long which can lead to stiffness and cramping.

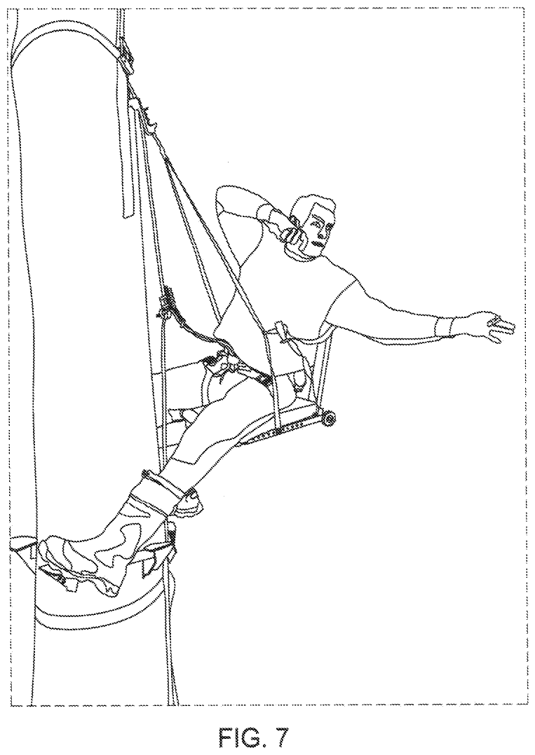

Referring to FIG. 7, the hunter is shown on the opposite side of the tree in the shooting position. One of the innovative aspects of the instant invention is the hunter can move around the entire azimuth of the tree circumference quickly and noiselessly. He also can lean over to get a better shot without fear because the harness, bosun's seat and trailing rope grab provide defense in depth against falling.

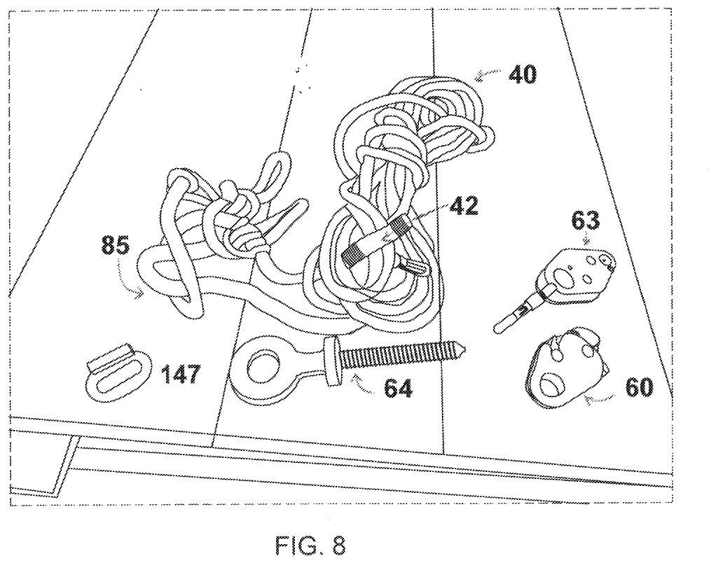

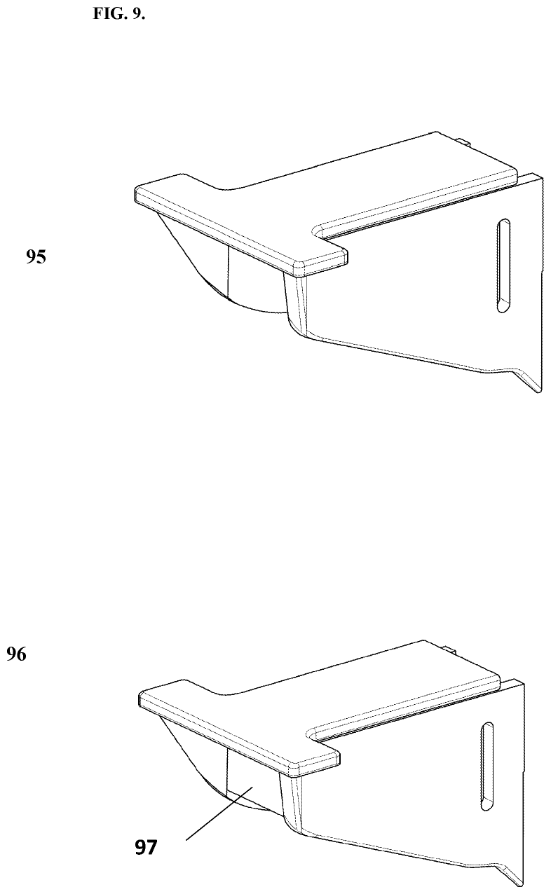

Referring to FIG. 8, several key components of the present invention are shown including the following:
a. a trailing rope grab 60. Many types of trailing rope grabs may be used. The key is that they be ANSI certified for use in trees and be safety rated for up to 500 lbs of weight.
b. a hand ascender 63. In an alternate mode, the hand ascender may be used instead of the friction knot.
c. climbing rope 40 with mechanical stop attached 42. In this instance, the climbing rope is an ANSI certified arborist's rated at more than 1,000 lbs. The mechanical stop can be any type of bar, cast iron, or piece of metal rated to several thousand pounds breaking strength that will hold the climbing rope in place when the mechanical stop engages the arborist's ring (attached to the ratchet strap) or the eye of the threaded eye bolt.
d. threaded eye bolt 64. This is installed during the initial setup of the apparatus on a given tree. Eventually, the tree will grow and the threaded eye bolt will become deeper and deeper embedded into the tree thereby forming a more and more secure attachment point. However, initially the ratchet strap with arborist's ring attached will be the primary attachment point. In addition, during initial uses (for the first year or two), the climbing rope may be threaded through both the threaded eye bolt and the ratchet strap/arborist's ring assembly.
e. a carabiner 147 used to attach the straps of the modified bosun's seat to the bottom of the friction knot.
f. a foot ascender 85

### METHOD OF OPERATION

The best mode for practicing the present invention is presented in the following sections: Initial Setup, Ascending the Tree, Using the Tree Stand at the Desired Height, and Descending the Tree.

### Initial Setup

A few preliminary steps must be taken before using the present invention.
1. The hunter must affix an attachment point at the desired height above the ground. Normally this will be between 20 and 30 feet above the ground, but any other height will suffice as desired by the hunter.
2. The hunter will have to install portable ladder sections (known in the industry as “sticks”) to reach the desired height. Alternatively, the hunter may use a ladder, use a lineman's climbing rope looped over a tree limb or any other means to reach and safely install the attachment point.
3. As mentioned above, the attachment point will most likely be an arborist's ring attached to a heavy duty ratchet strap (for the first year or two). At the same time, a threaded eye bolt will be screwed into the tree. Over time, as the tree grows, the threaded eye bolt will become deeply embedded into the tree and the need for the arborist's ring/ratchet strap assembly will be diminished.
4. The final step is to thread the throw rope through the arborist's ring and/or the threaded eye bolt. There should be sufficient length to the throw rope to allow it to reach the ground. Note that the throw rope may be left outside in the elements indefinitely as may the threaded eye bolt and ratchet strap/arborist's ring assembly. However, the other components of the instant invention may not be left out in the elements in order to comply with ANSI standards.

### Ascending the Tree.

In order to safely ascend a tree, the following steps are taken.
1. The hunter affixes or ensures that a heavy duty mechanical stop is safely and firmly affixed to the rope.
2. The throw rope is attached to the climbing rope at the opposite end of the climbing rope—i.e. the end that does not have the mechanical stop affixed to it,
3. The throw rope is pulled down such that the climbing rope is pulled up until the mechanical stop engages the arborist's ring or threaded eyebolt.
4. The hunter puts on the ANSI rated safety harness and connects it to the trailing rope grab.
5. The hunter attaches the modified bosun's seat to his/her back in the collapsed mode.
6. The climbing rope is threaded through the trailing rope grab.
7. The trailing rope grab is affixed to the safety harness.
8. A friction knot is attached to the climbing rope at approximately the level of the hunter's head. Note that in an alternate mode, an arborist's hand ascender can be used in place of the friction knot.
9. A foot ascender is attached at one end to the bottom loop of the friction knot.
10. The climbing rope is affixed to a foot ascender.
11. The foot ascender is looped around the hunter's foot.
12. One hand grasps the friction knot.
13. The other hand grasps the climbing rope below the point where the safety harness is attached.
14. The hunter begins the ascent by moving the friction knot up approximately twelve to eighteen inches with one hand. This has the effect of bringing the foot up.
15. The hunter then stands and pulls the climbing rope up with his other hand. This eliminates the slack in the climbing rope below the harness attachment point.
16. The hunter repeats these steps until he reaches the desired height. In general, it should take less than a minute to reach the desired height with this method.

### Using the Tree Stand at the Desired Height

Once the hunter has reached the desired height, the following steps are taken.
1. At the desired height, the hunter deploys the bosun's seat and adjusts the seat to the desired reclining or straight up position.
2. Straps on the side of the modified bosun's seat are attached to the carabiner or similar attachment device affixed to the bottom of the friction knot.
3. Then the harness is slacked such that there is minimal pressure on the major arteries of the upper leg.
4. At this point in time, the hunter is safely and comfortably seated in the modified bosun's chair.
5. The trailing rope grab will engage if the apparatus begins to fall.

### Descending the Tree

When the hunter desires to descend the tree, the following steps must be taken:
1. The hunter must remember to bring the throw line back to the ground level while descending.
2. When the hunter desires to descend the tree, he/she merely squeezes the friction knot gently and a slow controlled descent will begin.
3. If the hunter squeezes the friction knot too much and a more rapid descent begins, the trailing rope grab will engage and stop the descent.
4. Once on the ground, the hunter packs up the climbing rope, friction knot, trailing rope grab and the rest of the gear and either moves to the next tree or leaves the field for the day. The key is that only the throw line, the threaded eye bolt, and the optional ratchet strap with attached arborist ring remain outside in the environment.

While the preceding presents the best mode for practicing the instant invention, variations of the invention may be used in alternate modes. For example, the best mode contemplates use of a friction knot. Other similar knots may be used such as a Prusik knot or a VT Prusik knot may be used. In other modes, a hand ascender may be used instead of a friction knot. Other modes may include other types of attachment points permanently affixed to a tree. One mode contemplates leaving the sticks attached to a tree as a means of descending the tree in the event the trailing rope grab seizes. Or sticks may only be used to install the attachment points and then removed and used on another tree. The present invention contemplates use of a modified collapsible bosun's seat. However, other types of seats may be used as long as they do not compromise the safety features of the present invention. Finally, the instant invention specifies use of carabiners, while any type of appropriate weight tested reliable snap attachment may be used.

The following is claimed:

1. A lightweight, rapidly deployable, easily erectable, rapidly adjustable, inherently safe tree stand of the type used by hunters to ascend and remain for extended periods of time in a tree above the ground comprising at least some or all of the following:
a. a heavy duty climbing rope with a heavy duty mechanical stop affixed at one end;
b. a safety harness;
c. an adjustable, reclinable seat with back and head rest;
d. a trailing rope grab;
e. an optional arborist's hand ascender;
f. an attachment point;
g. a base walkway/footrest;
h. optional modular ladder sections known as sticks;
i. an optional safety life line;
j. a foot ascender;
k. a modified Prusik or VT-Prusik or any similar friction knot; and
l. a throw rope.

2. The inherently safe tree stand of claim 1 where the safety harness is an arborist's safety harness compliant with ANSI standards.

3. The inherently safe tree stand of claim 1 where the trailing rope grab is an arborist's trailing rope grab compliant with ANSI standards.

4. The inherently safe tree stand of claim 1 where the heavy duty climbing rope is an arborist's climbing rope compliant with ANSI standards.

5. The inherently safe tree stand of claim 1 where the adjustable reclinable seat is a modified bosun's seat that is collapsible and can be attached to the hunter's back while ascending the tree.

6. The inherently safe tree stand of claim 1 where all major safety components are removed from the tree and safely stored out of the elements after the hunter descends the tree.

7. The inherently safe tree stand of claim 1 where the mechanical stop affixed to one end of the arborist's rope is a cast iron bolt with a breaking strength of at least 2000 pounds.

8. A method of ascending a tree using a lightweight, rapidly deployable, easily erectable, rapidly adjustable, inherently safe tree stand comprising at least some or all of the following steps:
a. a hunter affixes or ensures that a heavy duty mechanical stop is safely and firmly affixed to a climbing rope;
b. a throw rope is attached to the climbing rope at the opposite end of the climbing rope, specifically to the end that does not have the mechanical stop affixed to it;
c. the throw rope is pulled down such that the climbing rope is pulled up until the mechanical stop engages the arborist's ring or threaded eyebolt;
d. the hunter dons an ANSI rated safety harness and connects it to a trailing rope grab.
e. the hunter attaches a modified collapsible bosun's seat to his/her back in the collapsed mode;
f. the climbing rope is threaded through the trailing rope grab;
g. the trailing rope grab is affixed to the safety harness;
h. a friction knot is attached to the climbing rope at approximately the level of the hunter's head;
i. a foot ascender is attached at one end to the bottom loop of the friction knot;
j. the climbing rope is affixed to the foot ascender;
k. the foot ascender is looped around the hunter's foot;
l. one of the hunter's hands grasps the friction knot;
m. the hunter's other hand grasps the climbing rope below the point where the safety harness is attached;
n. the hunter begins the ascent by moving the friction knot up approximately twelve to eighteen inches with one hand with the effect of bringing the foot up;
o. the hunter then stands and pulls the climbing rope up with his other hand thereby eliminating the slack in the climbing rope below the harness attachment point; and
p. the hunter repeats these steps until he reaches the desired height.

9. The method of claim 8 where the hunter deploys the collapsible seat upon reaching the desired height.

10. The method of claim 8 where upon reaching the desired height, the hunter deploys the collapsible seat and attaches the seat to the bottom of the friction knot thereby removing significant pressure on the hunter's upper legs due to slackening of the safety harness.

11. A lightweight, rapidly deployable, easily erectable, rapidly adjustable, inherently safe tree stand of the type used by hunters to ascend and remain for extended periods of time in a tree above the ground that comprises the following two features that prevent rapid uncontrolled descent from the tree stand:
a. a friction knot affixed to a climbing rope and
b. a trailing rope grab affixed to the climbing rope.

12. The inherently safe tree stand of claim 11 where the friction knot is a Prusik knot or a VT Prusik knot.

13. The inherently safe tree stand of claim 11 where the friction knot has at least four turns.

14. The inherently safe tree stand of claim 11 where the trailing rope grab is an ANSI approved device that is safely rated for at least 500 pounds.

15. A method of descending a tree using a lightweight, rapidly deployable, easily erectable, rapidly adjustable, inherently safe tree stand comprising at least some or all of the following steps:
a. ensuring that the throw line back to the ground level while descending;
b. squeezing the friction knot gently to initiate a slow controlled descent;
c. engaging the trailing rope grab to stop the descent if the hunter squeezes the friction knot too much and a more rapid or uncontrolled descent begins;
d. once safely on the ground, the hunter packs up the climbing rope, friction knot, trailing rope grab and the rest of the gear and either moves to the next tree or leaves the field for the day, thereby ensuring that only the throw line, the threaded eye bolt, and the optional ratchet strap with attached arborist ring remain outside in the environment; and
e. safely storing the climbing rope, friction knot, trailing rope grab, foot ascender, hand ascender, and carabiner out of the elements in order to preserve their safety ratings.
